(19) United States
(12) Patent Application Publication
(10) Pub. No.: US 2007/0106505 A1
(43) Pub. Date: May 10, 2007

(54) Audio coding

(75) Inventors: Andreas Johannes Gerrits, Eindhoven (NL); Albertus Cornelis Den Brinker, Eindhoven (NL); Felip Riera Palou, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninkijkle Phillips Electronics N.V.

(21) Appl. No.: 10/580,676

(22) PCT Filed: Nov. 24, 2004
(86) PCT No.: PCT/IB04/52539

§ 371 Date: May 26, 2006

(30) Foreign Application Priority Data
Dec. 1, 2003 (EP) 031044472.0

(51) Int. Cl. G10L 19/00

(52) U.S. Cl. 704/230

(57) ABSTRACT

An audio coder is arranged to process a respective set of sampled signal values for each of a plurality of sequential segments of an audio signal (x). The coder comprises an analyser (TSA) arranged to analyse the sampled signal values to provide one or more sinusoidal codes (Cs) corresponding to respective sinusoidal components of the audio signal. A subtractor subtracts a signal corresponding to the sinusoidal components from the audio signal to provide a first residual signal (r₁). A modeller (SEG) models the frequency spectrum of the first residual signal (r₁) by determining first filter parameters (Ps) of a filter which has a frequency response approximating a frequency spectrum of the first residual signal. Another subtractor subtracts a signal corresponding to the first filter parameters from the first residual signal to provide a second residual signal (r₂). Another modeller (RPE) models a component (r₂,r₃) of the second residual signal with a pulse train coder (RPE) to provide respective pulse train parameters (L₀). A bit stream generator (15) generates an encoded audio stream (AS) including the sinusoidal codes (Cs), the first filter parameters (Ps) and the pulse train parameters (L₀).

### FIELD OF THE INVENTION

The present invention relates to coding and decoding audio signals.

### BACKGROUND OF THE INVENTION

Referring now to FIG. 1, a parametric coding scheme in particular a sinusoidal coder is described in US Published Application No. 2001/0032087A1. In this coder, an input audio signal x(t) received from a channel 10 is split into several (overlapping) segments or frames, typically of length 20 ms. Each segment is decomposed into transient (C_{T}), sinusoidal (C_{S}) and noise (C_{N}) components. (It is also possible to derive other components of the input audio signal such as harmonic complexes although these are not relevant for the purposes of the present invention.)

The first stage of the coder comprises a transient coder 11 including a transient detector (TD) 110, a transient analyzer (TA) 111 and a transient synthesizer (TS) 112. The detector 110 estimates if there is a transient signal component and its position. This information is fed to the transient analyzer 111. If the position of a transient signal component is determined, the transient analyzer 111 tries to extract (the main part of) the transient signal component. It matches a shape function to a signal segment preferably starting at an estimated start position, and determines content underneath the shape function, by employing for example a (small) number of sinusoidal components. This information is contained in the transient code C_{T}.

The transient code C_{T} is furnished to the transient synthesizer 112. The synthesized transient signal component is subtracted from the input signal x(t) in subtractor 16, resulting in a signal x₂.

The signal x₂ is furnished to a sinusoidal coder 13 where it is analyzed in a sinusoidal analyzer (SA)130, which determines the (deterministic) sinusoidal components. The end result of sinusoidal coding is a sinusoidal code C_{S} and a more detailed example illustrating the conventional generation of an exemplary sinusoidal code C_{S} is provided in PCT patent application No. WO00/79519A1.

From the sinusoidal code C_{S}generated with the sinusoidal coder, the sinusoidal signal component is reconstructed by a sinusoidal synthesizer (SS) 131. This signal is subtracted in subtractor 17 from the input x₂ to the sinusoidal coder 13, resulting in a remaining signal x₃ devoid of (large) transient signal components and (main) deterministic sinusoidal components.

The remaining signal x₃ is assumed to mainly comprise noise and a noise analyzer 14 produces the noise code C_{N} representative of this noise, as described in, for example, PCT patent application No. WO01/89086A1.

FIGS. 2(a) and (b) show generally the form of an encoder (NE) suitable for use as the noise analyzer 14 of FIG. 1 and a corresponding decoder (ND) for use as the noise synthesizer 33 of FIG. 6 (described later). A first audio signal r₁, corresponding to the residual x₃ of FIG. 1, enters the noise encoder comprising a first linear prediction (SE) stage which spectrally flattens the signal and produces prediction coefficients (Ps) of a given order. More generally, a Laguerre filter can be used to provide frequency sensitive flattening of the signal as disclosed in E. G. P. Schuijers, A. W. J. Oomen, A. C. den Brinker and A. J. Gerrits, “Advances in parametric coding for high-quality audio.”, Proc. 1st IEEE Benelux Workshop on Model based Processing and Coding of Audio (MPCA-2002), Leuven, Belgium, 15 Nov. 2002, pp. 73-79. The residual r₂ enters a temporal envelope estimator (TE) producing a set of parameters Pt and, possibly, a temporally flattened residual r₃. The parameters Pt can be a set of gains describing the temporal envelope. Alternatively, they may be parameters derived from Linear Prediction in the frequency domain such as Line Spectral Pairs (LSPs) or Line Spectral Frequencies (LSFs), describing a normalised temporal envelope, together with a gain envelope.

In the parametric decoder (ND), a synthetic white noise sequence is generated (in WNG) resulting in a signal r₃′ with a temporally and spectrally flat envelope. A temporal envelope generator (TEG) adds the temporal envelope on the basis of the received, quantised parameters Pₜ′ and a spectral envelope generator (SEG, a time-varying filter) adds the spectral envelope on the basis of the received, quantised parameters P., resulting in a noise signal r₁′ corresponding to signal yₙ of FIG. 6.

In a multiplexer 15, an audio stream AS is constituted which includes the codes C_{T}, C_{S} and C_{N}.

The sinusoidal coder 13 and noise analyzer 14 are used for all or most of the segments and amount to the largest part of the bit rate budget.

It is well known that parametric audio coders can give a fair to good quality at relatively low bit rates for example 20 kbit/s. However, at higher bit rates the quality increase, as a function of increasing bit rate is rather low. Thus, an excessive bit rate is needed to obtain excellent or transparent quality. It is therefore difficult to attain transparency using parametric coding at bit rates comparable to those of, for example, waveform coders. This means that it is difficult to construct parametric audio coders having an excellent to transparent quality without an excessive usage of bit budget.

The reason for the fundamental difficulty in parametric coding reaching transparency is in the objects that are defined. The parametric coder is very efficient in encoding tonal components (sinusoids) and noisy components (noise coder). However, in real audio, a lot of signal components fall into a grey area: they can neither be modelled accurately by noise nor can they be modelled as (a small number of) sinusoids. Therefore, the very definition of objects in a parametric audio coder, though very beneficial from a bit rate point of view for medium quality levels, is the bottleneck in reaching excellent or transparent quality levels.

At the same time, traditional audio coders (sub-band and transform) give excellent to transparent coding quality at certain bit rates, typically in the order of 80-130 kbit/s for stereo signals sampled at 44.1 kHz. Combinations of transform and parametric coders (so-called hybrid coders) have been proposed for example as disclosed in European patent application no. 02077032.7 filed on May 24, 2002 (Attorney Docket No. ID 609811/PHNL020478). Here spectro-temporal intervals of an audio signal, which would otherwise be sub-band coded, are selectively coded with noise parameters in an attempt to reduce bit rate while maintaining audio quality.

Alternatively, a transform or sub-band coder might be cascaded with a parametric coder of the type shown in FIG. 1. However, the expected coding gain for such an arrangement, where the parametric coder is preceding the transform or sub-band coder, is minimal. This because the perceptually most important regions of the audio signal would be captured by the sinusoidal coder, leaving little possibility for coding gain in the transform/sub-band coder.

Audio coders using spectral flattening and residual signal modelling using a small number of bits per sample are disclosed in A. Harma and U.K. Laine, “Warped low-delay CELP for wide-band audio coding”, Proc. AES 17th Int. Conf.: High Quality Audio Coding, pages 207-215, Florence, Italy, 2-5 Sep, 1999; S. Singhal, “High quality audio coding using multi-pulse LPC”, Proc. 1990 Int. Conf. Acoustic Speech Signal Process. (ICASSP90), pages 1101-1104, Atlanta Ga., 1990, IEEE Picataway, N.J.; and X. Lin, “High quality audio coding using analysis-by synthesis technique”, Proc. 1991 Int. Conf. Acoustic Speech Signal Process. (ICASSP91), pages 3617-3620, Atlanta Ga., 1991, IEEE Picataway, N.J. In a number of studies, it has been shown that this coding strategy enables an excellent to transparent quality at bit rates corresponding to 2 bit/sample for mono signals (88.2 kbit/s for 44.1 kHz audio). In that respect, they do not exceed the performance of sub-band or transform coders.

It is an object of the present invention to provide a parametric audio coder whose bit rate is controllable across a range and which provides high quality levels at a bit rate comparable with traditional coders.

### DISCLOSURE OF THE INVENTION

According to the present invention, there is provided a method according to claim 1.

The invention provides scalability in a parametric coder, by supplementing the noise coder with a pulse train coder. This provides a large range of bit rate operating points and merges the two strategies into one coder without introducing a large overhead in complexity.

The coding strategies within the noise coder are complementary in terms of strengths and weaknesses. The Linear Predictor in the pulse train coder, for example, is inefficient in describing a tonal audio segment, but the sinusoidal coder can do this efficiently. Thus, for tonal items like harpsichord, the pulse train coder is unable to deliver transparent quality for a coarse quantisation of the residual. For other signals, the prediction order of the pulse train coder linear prediction stage has to be very high to allow a coarse quantisation of the residual. For noise like signals, decimation of the residual signal is a problem and leads to a loss of brightness.

In the preferred embodiment, the coding strategies are combined to form a base layer using the parametric coder and an additional (bit rate controlled) pulse train layer. The bit rate resources required for the combined techniques are less than the bit rate requirements per technique since both methods apply spectral flattening and, consequently, the bits needed for this stage only have to be invested once. With the preferred embodiment, a bit rate range from 20-120 kbit/s (for stereo signals) can be covered with performance better than or comparable with that of state-of-the-art coders.

### BRIEF DESCRIPTION OF THE DRAWINGS

Embodiments of the invention will now be described, by way of example, with reference to the accompanying drawings, in which:

FIG. 1 shows a conventional parametric coder;

FIGS. 2(a) and (b) show a conventional parametric noise encoder (NE) and corresponding noise decoder (ND) respectively;.

FIG. 3 shows an overview of a mono encoder according to a preferred embodiment of the present invention;

FIG. 4 shows an overview of a mono decoder according to a first embodiment of the present invention; and

FIG. 5 shows an overview of a mono decoder according to a second embodiment of the present invention.

### DESCRIPTION OF THE PREFERRED EMBODIMENTS

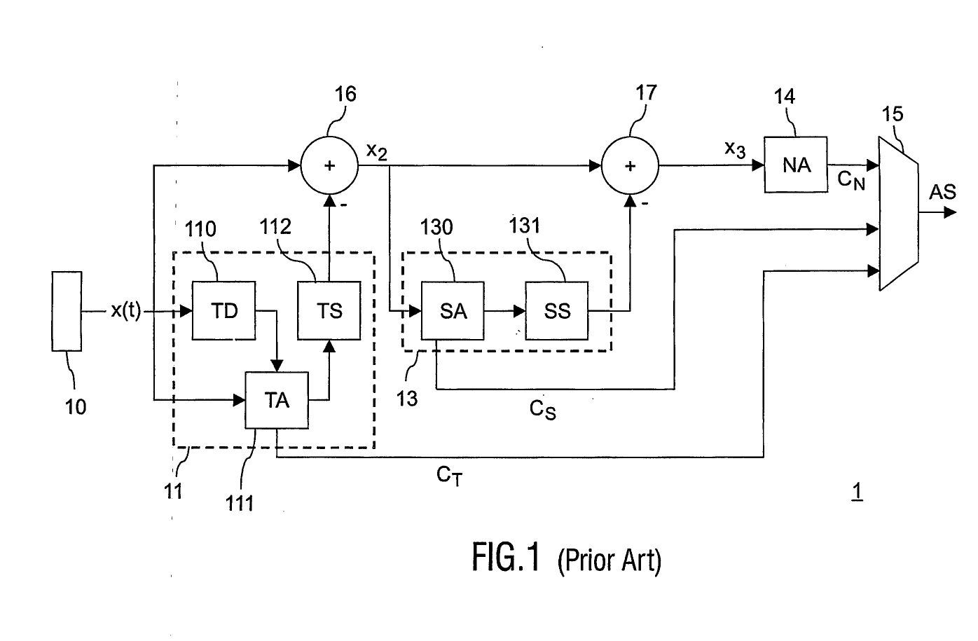

In the preferred embodiment, a parametric audio coder of the type shown in FIG. 1 is supplemented with a pulse train coder of the type described in P. Kroon, E. F. Deprettere and R. J. Sluijter, “Regular Pulse Excitation—A novel approach to effective and efficient multipulse coding of speech”, IEEE Trans. Acoust. Speech, Signal Process, 34, 1986. Nonetheless, it will be seen that while the embodiment is described in terms of a Regular Pulse Excitation (RPE) coder, the invention can equally be implemented with Multi-Pulse Excitation (MPE) techniques as disclosed in U.S. Pat. No. 4,932,061 or an ACELP coder as described K. Jarvinen, J. Vainio, P. Kapanen, T. Honkanen, P. Haavisto, R. Salami, C. Laflamme, J-P. Adoul, “GSM enhanced full rate speech codec”, Proc. ICASSP-97, Munich (Germany), 21-24 Apr. 1997, Volume 2, pp. 771-774, each of which include a first LP based spectrally flattening stage.

In the preferred embodiment, an overall bit rate budget determined according to the quality required from the coder, is divided into a bit-rate B usable by the parametric coder and an RPE coding budget which is inversely proportional to an RPE decimation factor D.

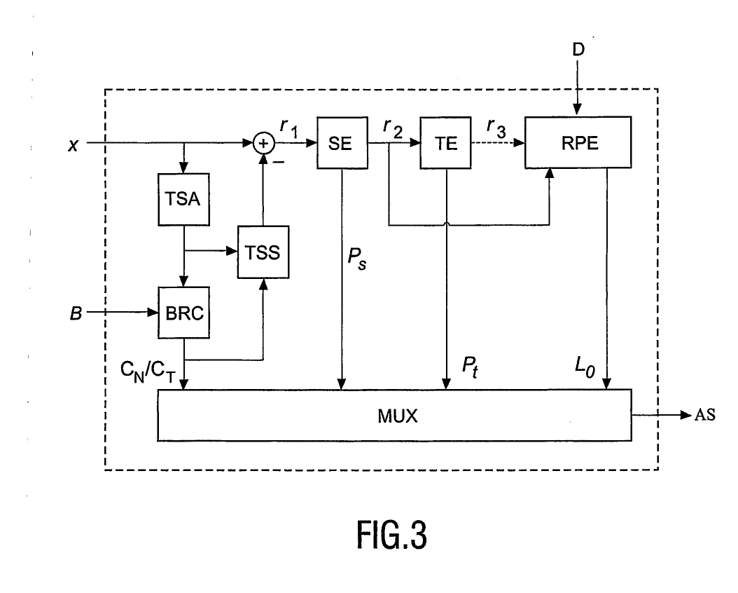

Referring now to FIG. 3, an input audio signal x is first processed within block TSA, (Transient and Sinusoidal Analysis) corresponding with blocks 11 and 13 of the parametric coder of FIG. 1. Thus, this block generates the associated parameters for transients and noise as described in FIG. 1. Given the bit rate B, a block BRC (Bit Rate Control) preferably limits the number of sinusoids and preferably preserves transients such that the overall bit rate for sinusoids and transients is at most equal to B, typically set at around 20 kbit/s.

A waveform is generated by block TSS (Transient and Sinusoidal Synthesiser) corresponding to blocks 112 and 131 of FIG. 1 using the transient and sinusoidal parameters (C_{T} and C_{S}) generated by block TSA and modified by the block BRC. This signal is subtracted from input signal x, resulting in signal r₁ corresponding to residual x₃ in FIG. 1. In general, signal r₁ does not contain sinusoids and transients.

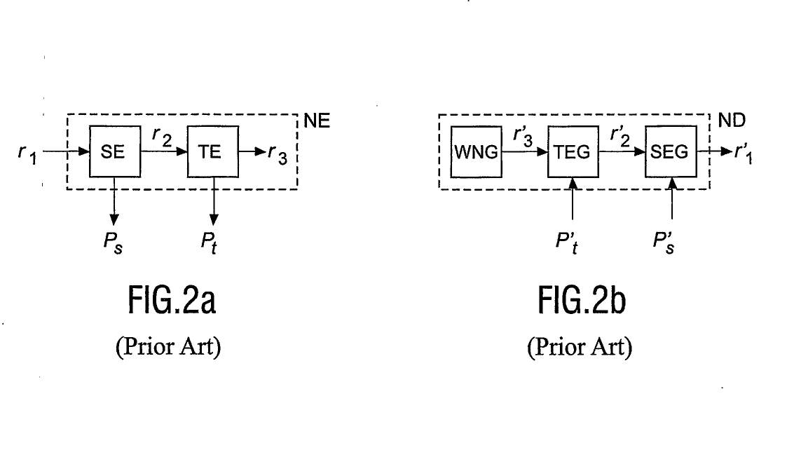

From signal r₁, the spectral envelope is estimated and removed in the block (SE) using a Linear Prediction or a Laguerre filter as in the prior art FIG. 2(a). The prediction coefficients Ps of the chosen filter are written to a bitstream AS for transmittal to a decoder as part of the conventional type noise codes C_{N}. Then the temporal envelope is removed in the block (TE) generating, for example, Line Spectral Pairs (LSP) or Line Spectral Frequencies (LSF) coefficients together with a gain, again as described in the prior art FIG. 2(a). In any case, the resulting coefficients Pt from the temporal flattening are written to the bitstream AS for transmittal to the decoder as part of the conventional type noise codes C_{N}. Typically, the coefficients Ps and PT require a bit rate budget of 4-5 kbit/s.

Because pulse train coders employ a first spectral flattening stage, the RPE coder can be selectively applied on the spectrally flattened signal r₂ produced by the block SE according to whether a bit rate budget has been allocated to the RPE coder. In an alternative embodiment, indicated by the dashed line, the RPE coder is applied to the spectrally and temporally flattened signal r₃ produced by the block TE.

As is known from the documents referred to in the background, the RPE coder performs a search in an analysis-by-synthesis manner on the residual signal r₂/r₃. Given a decimation factor D, the RPE search procedure results in an offset (value between 0 and D-1), the amplitudes of the RPE pulses (for example, ternary pulses with values −1, 0 and 1) and a gain parameter. This information is stored in a layer Lo included in the audio stream AS for transmittal to the decoder by a multiplexer (MUX) when RPE coding is employed.

Typically, the RPE coder require a bit rate of at least 40 kbit/s or so and is therefore switched on as the quality requirement and so bit budget of the encoder is increased towards the higher end of the quality range. For the lower part of the quality range where the RPE coder is initially employed, the bit rate B is decreased to less than the maximum bit rate allowed for when the parametric coder is employed alone. This enables a monotonically increasing overall bit rate budget range to be specified for the coder with quality increasing in proportion to the budget.

Experiments showed that the RPE coder results in a loss in brightness in the reconstructed signal, especially when using high decimation factors (e.g. D=8). Adding some low-level noise to the RPE sequence mitigates this problem. In order to determine the level of the noise, a gain (g) is calculated on basis of, for example, the energy/power difference between a signal generated from the coded RPE sequence and residual signal r₂/r₃. This gain is also transmitted to the decoder as part of the layer L₀ information.

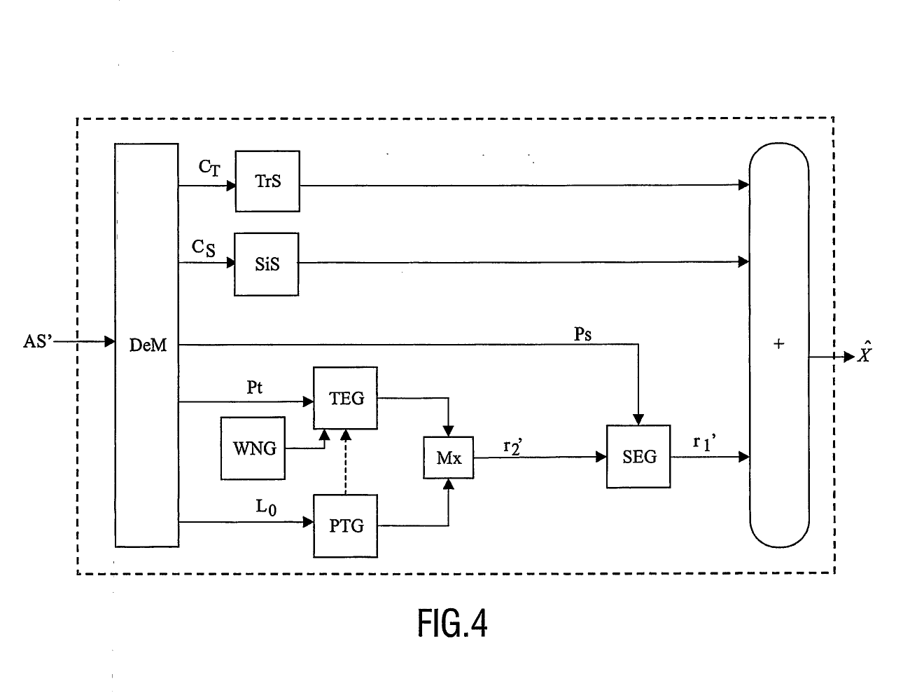

Referring now to FIG. 4, a first embodiment of the decoder compatible with the embodiment of FIG. 1 where the RPE block processes the residual signal r₂ is shown. A de-multiplexer (DeM) reads an incoming audio stream AS′ and provides the sinusoidal, transient and noise codes (Cs, C_{T} and C_{N}(Ps,P_{T})) to respective synthesizers SiS, TrS and TEG/SEG as in the prior art. As in the prior art, a white noise generator (WNG) supplies an input signal for the temporal envelope generator TEG. In the embodiment, where the information is available, a pulse train generator (PTG) generates a pulse train from layer L₀ and this is mixed in block Mx to provide an excitation signal r₂′. It will be seen from the encoder, that as the noise codes C_{N}(Ps,P_{T}) and layer L₀ were generated independently from the same residual r₂, the signals they generate need to be gain modified to provide the correct energy level for the synthesized excitation signal r₂′. In this embodiment, in a mixer (Mx), the signals produced by the blocks TEG and PTG are frequency weighted, so that for low frequencies, most of the signal r₂′ is derived from the pulse coded information L₀ and for high frequencies most of the signal r₂′ is derived from the synthesized noise source WNG/TEG.

The excitation signal r₂′ is then fed to a spectral envelope generator (SEG) which according to the codes Ps produces a synthesized noise signal r₁′. This signal is added to the synthesized signals produced by the conventional transient and sinusoidal synthesizers to produce the output signal \hat{x}.

In an alternative embodiment, the signal generated by the pulse train generator PTG is used instead of the signal generated by WNG as an input to the temporal envelope generator as indicated by the hashed line.

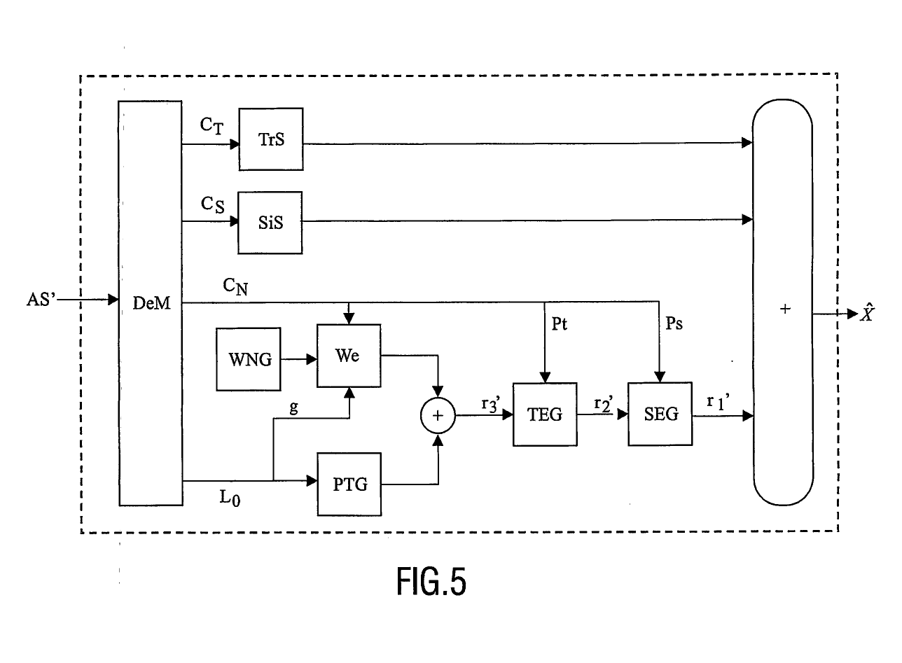

Referring now to FIG. 5, a second embodiment of the decoder corresponds with the embodiment of FIG. 1 where the RPE block processes the residual signal r₃. Here, the signal generated by a white noise generator (WNG) and processed by a block We, based on the gain (g) determined by the coder; and the pulse train generated by the pulse train generator (PTG) are added to construct an excitation signal r₃′. Where layer L₀ information is available, within block We, the noise sequence is high-pass filtered to remove the low frequencies, which perceptually degrade the reconstructed excitation signal—as in the first embodiment of the decoder, these components of the synthesized noise signal are based on the output of the pulse train generator rather than the noise based excitation signal. Of course, where layer Lo information is not available, the white noise is fed through the block We to be provided as the excitation signal r₃′ to a temporal envelope generator block (TEG).

The temporal envelope coefficients (P_{T}) are then imposed on the excitation signal r₃′ by the block TEG to provide the synthesized signal r₂′ which is processed as before. As mentioned above, this is advantageous because a pulse train excitation typically gives rise to some loss in brightness which, with a properly weighted additional noise sequence, can be counteracted. The weighting can comprise simple amplitude or spectral shaping each based on the gain factor g.

As before, the signal is filtered by, for example, a Laguerre filter in block SEG (Spectral Envelope Generator), which adds a spectral envelope to the signal. The resulting signal is then added to the synthesized sinusoidal and transient signal as before.

It will be seen that in either FIG. 4 or FIG. 5, if no PTG is being used, the decoding scheme resembles the conventional sinusoidal coder using a noise coder only. If the PTG is used, a RPE sequence is added, which enhances the reconstructed signal i.e. provides a higher audio quality.

It should be noted that in the embodiment of FIG. 5, in contrast to the standard pulse coder (RPE or MPE), where a gain which is fixed for a complete frame is used, a temporal envelope is incorporated in the signal r₂′. By using such a temporal envelope, a better sound quality can be obtained, because of the higher flexibility in the gain profile compared to a fixed gain per frame.

1. A method of encoding an audio signal (x), the method comprising, for each of a plurality of segments of the signal, the steps of:
analysing (TSA) the sampled signal values to provide one or more sinusoidal codes (Cs) corresponding to respective sinusoidal components of the audio signal;
subtracting a signal corresponding to said sinusoidal components from said audio signal to provide a first residual signal (r₁);
modelling (SE) the frequency spectrum of the first residual signal (r₁) by determining first filter parameters (Ps) of a filter which has a frequency response approximating a frequency spectrum of the first residual signal;
subtracting a signal corresponding to said first filter parameters from the first residual signal to provide a second residual signal (r₂);
modelling (RPE) a component (r₂, r₃) of the second residual signal with a pulse train coder (RPE) to provide respective pulse train parameters (L₀); and generating (15) an encoded audio stream (AS) including said sinusoidal codes (Cs), said first filter parameters (Ps) and said pulse train parameters (L₀).

2. A method as claimed in claim 1 further comprising the steps of:
modelling (TE) the temporal envelope of each second residual signal by determining second parameters (Pₜ), and
providing a third residual signal (r₃) by removing from the second residual signal the temporal envelope corresponding to said second parameters;
wherein said component of the second residual signal comprises a respective third residual signal (r₃) and
wherein said generating step includes said second parameters in said encoded audio stream (AS).

3. A method as claimed in claim 1 further comprising the step of:
modelling (TEG) the temporal envelope of the second residual signal by determining second parameters (P_{T}), and
wherein said component of each second residual signal comprises said second residual signal (r₂); and
wherein said generating step includes said second parameters in said encoded audio stream (AS).

4. A method as claimed in claim 2 further comprising the step of:
estimating a difference between a signal corresponding to said pulse train parameters and said component (r₂, r₃) of each second residual signal; and
wherein said generating step includes an indicator of said difference (g) in said encoded audio stream (AS).

5. A method as claimed in claim 1 wherein said pulse train coder is one of a regular pulse excitation (RPE) coder; a multiple-pulse excitation (MPE) coder; or an ACELP coder.

6. A method as claimed in claim 1 wherein said first filter parameters (Ps) comprise one of: Laguerre or Linear Prediction filter parameters.

7. A method as claimed in claim 2 wherein said second parameters (P_{T}) comprise one of: Linear Prediction parameters or Line Spectral Pairs (LSP) or Line Spectral Frequencies (LSF) coefficients together with respective gains.

8. A method as claimed in claim 1 wherein said method comprises the step of:
estimating (TSA) a position of a transient signal component in the audio signal;
matching a shape function having shape parameters and a position parameter to said transient signal; and
including (15) the position and shape parameters describing the shape function in said audio stream (AS).

9. A method as claimed in claim 1 wherein the number of said sinusoidal components is limited by a first bit rate budget (B), wherein said pulse train coder is limited to producing said pulse train parameters (L₀) within a second bit rate budget, and wherein the sum of said first and second bit rate budgets is selected from a range according to a required quality of encoding.

10. Method of decoding an audio stream, the method comprising the steps of:
reading (DeM) an encoded audio stream (AS′) including, for each of a plurality of segments of an audio signal: sinusoidal codes (CS), pulse train parameters (L₀), and first filter parameters (Ps); and
employing (SiS) said sinusoidal codes to synthesize respective sinusoidal components of the audio signal;
employing (PTG) said pulse train parameters (L₀) to generate an excitation signal;
imposing (SEG) a spectral envelope according to said first filter parameters (Ps) on a first signal (r₂′) a component of which comprises said excitation signal, and
adding said synthesized sinusoidal components and said spectrally filtered signal to produce a synthesized audio signal (\hat{x}).

11. A method according to claim 10 wherein said encoded audio stream includes second parameters (P_{T}), said method comprising the step of:
imposing (TEG) a temporal envelope according to said second filter parameters (P_{T}) on a second signal (r₃′) a component of which comprises said excitation signal, and
wherein said first signal comprises said temporally filtered signal (r₂′).

12. A method according to claim 11 further comprising the steps of:
generating (WNG) a white noise signal; and
adding said white noise signal to said excitation signal to provide said second signal (r₃′).

13. A method according to claim 12 further comprising:
high-pass filtering (We) said white noise signal.

14. A method according to claim 12 wherein a gain (g) to be applied to said white noise signal is read from said audio stream.

15. A method according to claim 10 wherein said encoded audio stream includes second filter parameters (P_{T}), the method comprising the step of:
imposing (TEG) a time domain envelope according to said second filter parameters (Ps) on said excitation signal, and
wherein said spectral envelope is imposed on said temporally filtered signal (r₂′).

16. A method according to claim 10 wherein said encoded audio stream includes second filter parameters (P_{T}), the method comprising the steps of:
generating (WNG) a white noise signal;
imposing (TEG) a time domain envelope according to said second filter parameters (Ps) on the white noise signal, and
mixing said temporally filtered white noise signal with said excitation signal to provide said second signal (r₂′);
wherein said spectral envelope is imposed on said second signal (r₂′).

17. A method according to claim 16 wherein said mixing step comprises spectrally weighting said temporally filtered white noise signal and said excitation signal.

18. Audio coder arranged to process a respective set of sampled signal values for each of a plurality of sequential segments of an audio signal (x), said coder comprising:
an analyser (TSA) arranged to analyse the sampled signal values to provide one or more sinusoidal codes (Cs) corresponding to respective sinusoidal components of the audio signal;
a subtractor arranged to subtract a signal corresponding to said sinusoidal components from said audio signal to provide a first residual signal (r₁);
a modeller (SEG) arranged to model the frequency spectrum of the first residual signal (r₁) by determining first filter parameters (Ps) of a filter which has a frequency response approximating a frequency spectrum of the first residual signal;
a subtractor arranged to subtract a signal corresponding to said first filter parameters from the first residual signal to provide a second residual signal (r₂);
a modeller (RPE) arranged to model a component (r₂,r₃) of the second residual signal with a pulse train coder (RPE) to provide respective pulse train parameters (L₀); and
a bit stream generator (15) for generating an encoded audio stream (AS) including said sinusoidal codes (Cs), said first filter parameters (Ps) and said pulse train parameters (L₀).

19. Audio player, comprising:
means for reading (DeM) an encoded audio stream (AS′) including, for each of a plurality of segments of an audio signal:
sinusoidal codes (CS), pulse train parameters (L₀), and first filter parameters (Ps); and
a synthesizer (SiS) arranged to employ said sinusoidal codes to synthesize respective sinusoidal components of the audio signal;
means (PTG) for generating an excitation signal from said pulse train parameters (L₀);
means for imposing (SEG) a spectral envelope according to said first filter parameters (Ps) on a first signal (r₂′) a component of which comprises said excitation signal, and
an adder for adding said synthesized sinusoidal components and said spectrally filtered signal to produce a synthesized audio signal (\hat{x}).

20. Audio system comprising an audio coder as claimed in claim 18.

21. Audio stream (AS) comprising sinusoidal codes (Cs) corresponding to respective sinusoidal components of an audio signal (x); first filter parameters (Ps) for a filter which has a frequency response approximating a frequency spectrum of a first residual signal, said first residual signal corresponding to said audio signal with a signal corresponding to said sinusoidal components subtracted; and pulse train parameters (L₀) modelled from a component (r₂,r₃) of a second residual signal, said second residual signal corresponding to first residual signal with a signal corresponding to said first filter parameters subtracted.

22. Storage medium on which an audio stream (AS) as claimed in claim 21 has been stored.
